(19) United States
(12) Patent Application Publication
(10) Pub. No.: US 2007/0255458 A1
(43) Pub. Date: Nov. 1, 2007

(54) System and method for managing stratified liquids in storage tanks

(76) Inventor: Keith R. Haslem, Duchesne, UT (US)

Correspondence Address: Edwin L. Hartz, Suite 115, 619 Main Street, Grand Junction, CO, 81501, US

(21) Appl. No.: 11/413,774

(22) Filed: Apr. 28, 2006

(51) Int. Cl. G05D 7/00

(52) U.S. Cl. 700/282; 210/513

(57) ABSTRACT

A system for managing stratified liquids in a storage tank includes a variable height, in-tank sonar transducer, configured to identify liquid layers of differing densities and to indicate an elevation of the liquid layers, a motorized drive unit for adjusting an orifice to intercept a selected layer, wireless data transmission technology, and software to facilitate remote operation of the system.

### BACKGROUND

1. Field of the Invention

The present invention relates generally to systems for managing stratified layers of liquids in containers. More particularly, the present invention relates to a sonar sensing device (or other types of devices, such as ultrasonic sensors, electrical impedance sensors or optical sensors), disposed in a liquid storage tank, for identifying stratified layers of liquids and for enabling an operator to accurately add to or remove a selected layer of liquid.

2. Related Art

It is not uncommon for liquid storage tanks to contain liquids of different densities. For example, tanks for the storage of natural gas, crude oil, petrochemicals, wastewater, etc., frequently include, for example, a layer of water, along with one or more layers of less dense hydrocarbon materials. These will naturally separate into stratified layers of different liquids, the more dense liquids naturally resting at the bottom of the tank. Because of this phenomenon, a liquid that is desired from the tank may not be the liquid at the bottom of the tank. Consequently, apparatus and methods have been developed to allow extraction of or addition to liquids from different levels in liquid containers such as storage tanks. Useful apparatus and methods are disclosed in U.S. Application Ser. No. 60/651,239 filed Feb. 9, 2005, and assigned to the same Assignee as this application, the disclosure of which is incorporated herein in full.

In order to determine the location of a desired layer of liquid in a storage tank, various types of sensing systems and methods have been devised. These systems and methods allow a user to identify the various stratified layers, and determine the relative volume of the each layer of liquid in the tank. For example, fixed-height sonar sensing equipment in an oil storage tank may readily identify the precise point where the light-oil layer ends and the heavy-oil layer begins, for example, 26″ down from the top of the tank. Using this information, the operator may then go to the top of the tank and manually position an outlet valve at the 26″ level, and then remove the light-oil layer.

The outlet valve may incorporate a measuring device that protrudes through the top of the tank, to indicate the distance from the inlet valve to a fixed point on the top of the tank. In such cases the operator goes to the top of the tank to see the measuring device in relation to the fixed point and to manually position the inlet of the valve. The positioning of the valve may be automated and controlled without going to the top of the tank.

At present, fixed-height sensors must generally be installed through the tank wall. Unfortunately, this may not be practical to install on tanks that are currently in service. Further, a fixed-height sensor must be installed as near the bottom as possible, yet if the sensor is installed too near the bottom, BS&W (bottom sediment & water) could engulf the sensor, rendering it ineffective. Likewise, if the sensor is installed too high up in the tank, the liquid could drop below the level of the sensor, again rendering it ineffective. Another limitation of fixed-height sensors, which must reside near the bottom of the tank and face upward, is the tendency of sedimentation in the tank to settle on the face of the sensor, causing its signal to degrade and, ultimately, to be eliminated altogether.

### SUMMARY

It has been recognized that it would be advantageous to develop an automated system that would allow the monitoring of a liquid storage tank and the accurate, remote management of a stratified layer of liquid from a tank.

In accordance with one aspect thereof, a variable elevation, in-tank sonar transducer may be used with a telescoping valve, a motorized drive unit for adjusting the telescoping valve; an external power source; and wireless, data-transmission/reception technology, allowing for long-range remote monitoring and control of the telescoping valve based on sonar data. Further, a desk-top computer software application may enable an operator to view a graphical representation of each tank and with the computer providing various types of analytical reports for individual tanks, as well as for groups of tanks in a region. Additionally, a hand-held computer device may be used on-site to monitor the storage tank and to adjust the valve.

The in-tank sonar sensing device may be of any type (fixed-height, through-the-wall; variable-height on a float system; bi-directional, transducer mounted to the housing for the inlet/outlet orifice of a telescoping liquid management valve). The operator, working on top of the storage tank, utilizes information from the sonar system and manually adjusts (either by crank and gears moving an adjusting rod or by moving the adjusting rod by hand) the inlet/outlet orifice of the telescoping valve to a precise point corresponding with a stratified layer of liquid. For example, the sonar system may identify the light oil layer as beginning 12″ down from the top and extending to 26″ down from the top of the tank. Using this information, in conjunction with the measuring and adjusting rod on the telescoping valve, the operator may position the orifice of the valve at or near the 26″ level.

The sonar transducer and other devices for determining the level of each liquid may accurately identify each transition between different types of liquids. When the transition is readily identifiable, the orifice may be positioned at or near the transition of the selected liquid above the unwanted liquid. When the transition is not clearly identifiable, the orifice may be positioned a fixed distance above the zone where the transition takes place.

The sonar transducer may be a bi-directional, multi-phase transducer mounted to the inlet/outlet orifice housing of a telescoping valve with a motorized drive unit for adjusting the position of the orifice, as well as other components listed above. By mounting the transducer to the orifice housing, the sonar console knows precisely where the valve is located in relation to the stratified layers.

The sonar transducer may be mounted to a floating ring-shaped device that encircles the measuring and adjusting rod and floats on top of the clean oil layer.

A sonar transducer may be mounted to a floating ring-shaped device that encircles a telescoping pole, or rod, that secures itself to the top and bottom of the tank via pressure and friction as the pole is lengthened via telescoping action during installation. The pole is positioned close enough to the inlet/outlet orifice to allow the transducer to detect the orifice of the telescoping valve even when the liquid in the tank is very low. The pole and float vertically align the transducer with the orifice of the telescoping valve. The transducer is positioned in such a way that the sonar consul knows precisely where the orifice is located in relation to the stratified layers.

A through-the-tank-wall, sonar transducer is placed to detect the orifice of the telescoping valve. A horizontal, protruding member may be added to the housing of the orifice of the telescoping valve to facilitate detection by the transducer.

A bi-directional, specified-height transducer may be attached to a telescoping pole at a fixed distance from the bottom of the tank specified at installation, depending on the type of tank in question and the types and quantities of stratified liquids in question.

Several sets of electrical impedance sensors may be attached to a telescoping pole to provide readings of the specific gravities of liquids in a tank at close intervals, for example, every ½ inch or every inch, and used in conjunction with a telescoping liquid management valve.

Several sets of optical sensors may be attached to a telescoping pole to provide readings of the specific gravities of liquids in a tank at close intervals, for example, every ½ inch or every inch and used in conjunction with a telescoping liquid management valve.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a schematic view of an oil-storage tank;

FIG. 2 is a schematic view of inside an oil-storage tank containing a telescoping valve with a hi-directional, sonar transducer mounted to the valve inlet/outlet orifice housing with a manually operated crank, in accordance with the present invention;

FIG. 3 is a schematic view of inside an oil-storage tank containing two types of telescoping liquid management valves and a fixed-height, through-the-tank-wall sonar sensor, in accordance with the present invention;

FIG. 4 is an exploded view of an electric motor with gear reduction affixed to the drive assembly of a valve, in accordance with the present invention;

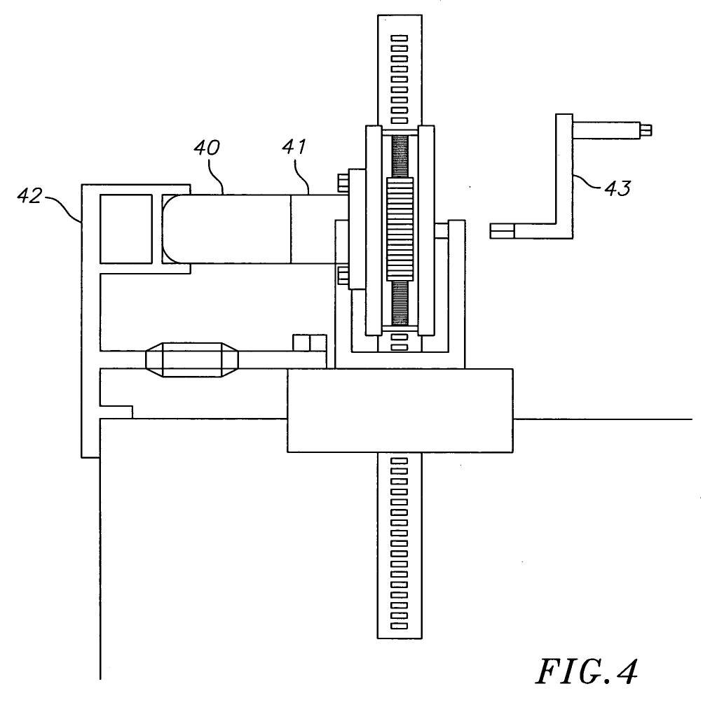

FIG. 5 is a schematic view of inside an oil-storage tank containing a telescoping liquid management valve with a sonar transducer mounted to a ring shaped float encircling the telescoping valve, in accordance with the present invention;

FIG. 6 is a schematic view of inside an oil-storage tank containing a telescoping liquid management valve and a telescoping pole with a sonar transducer mounted to a ring shaped float encircling the pole, in accordance with the present invention;

FIG. 7 is a front-elevation view of a Bluetooth enabled, programmable PDA useful with the apparatus, in accordance with the present invention;

FIG. 8 is a schematic view of the interior of a tank with adjustable, fixed-height sonar transducer affixed to a telescoping pole, in accordance with the present invention;

FIG. 9 is a schematic view of the interior of a tank with a single-stage telescoping liquid management valve placed in close proximity to a through-the-wall sonar transducer, in accordance with the present invention;

FIG. 10 is a schematic view of the interior of a tank with of a multi-stage telescoping liquid management valve and a through-the-wall sonar transducer, in accordance with the present invention;

FIG. 11 is inside a tank, of a two-piece, surface float with a sonar transducer affixed, in accordance with the present invention;

FIG. 12 is a schematic of the interior of a tank with a plurality of vertically spaced electrical impedance sensors, in accordance with the present invention; and

FIG. 13 is a report available on a display or hard copy, in accordance with the present invention.

### DETAILED DESCRIPTION

Reference will now be made to the exemplary embodiments illustrated in the drawings, and specific language will be used-herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The invention advantageously combines components and methodology of electronic automation with telescoping liquid management valves and in-tank, variable-height sonar sensing equipment to enable the accurate management of stratified layers in an oil storage tank, or other similar type of tank in a different industry, without the operator physically going to the top of the tank and adjusting the position of the inlet/outlet orifice of the valve to the correct height.

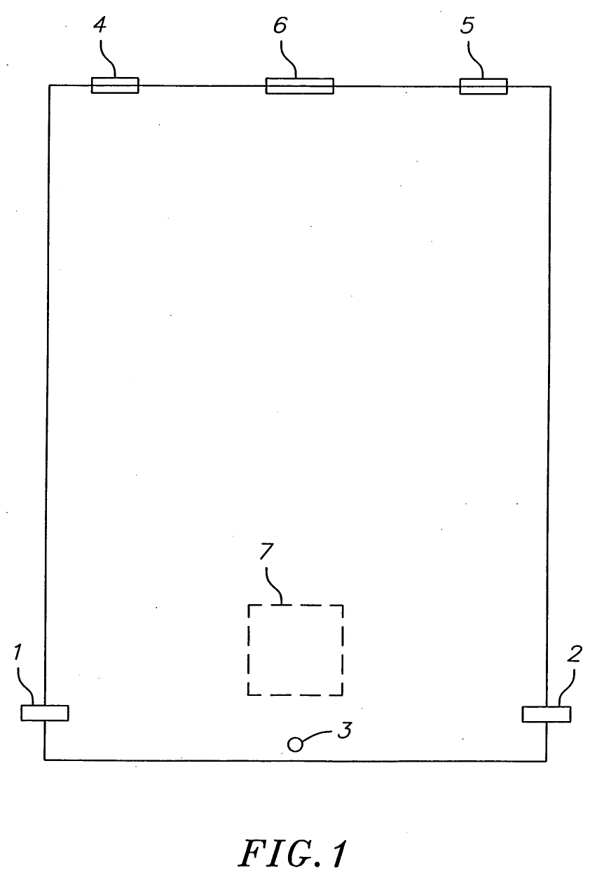

FIG. 1 shows an example of an oil storage tank in which the present invention may be used. A similar tank is available from the NATCO Group of Houston Tex. Such tanks are generally available in multiple sizes, a common one being 400 barrels, which is 20′ tall and 10′ in diameter. The tanks are made of steel and have three liquid outlet valves: two 4″ valves 1, 2, positioned 16″ above the bottom of the tank and on opposite sides of the tank and one 4″ valve 3 positioned 4″ above the bottom of the tank.

Such tanks generally have three openings at the top (two 4″ openings 4,5, with threaded caps and one 8″ opening 6 with a spring loaded pressure cap), one large opening 7 in the side of the tank for entry into the tank, and a pressure release valve, designed to prevent pressure inside the tank from exceeding a certain, pre-specified limit.

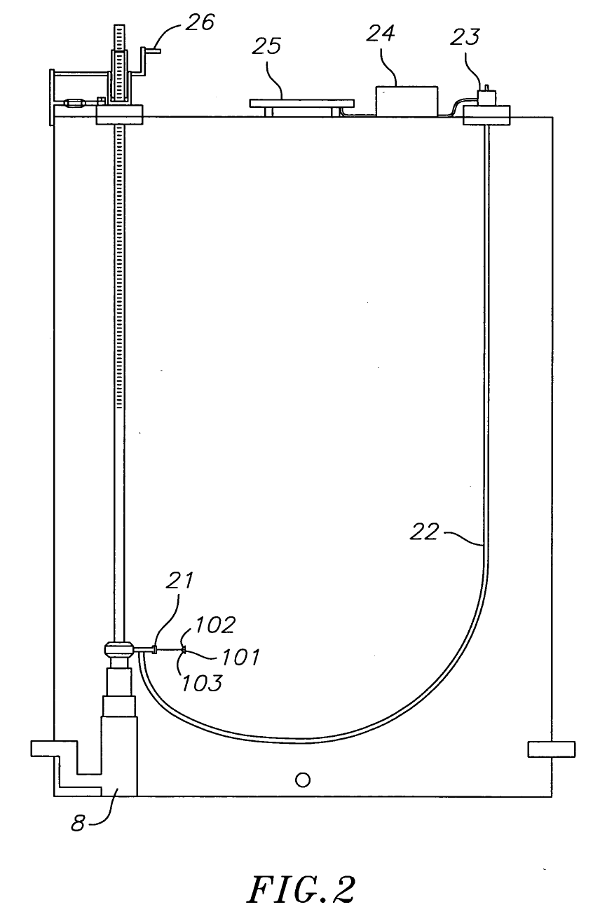

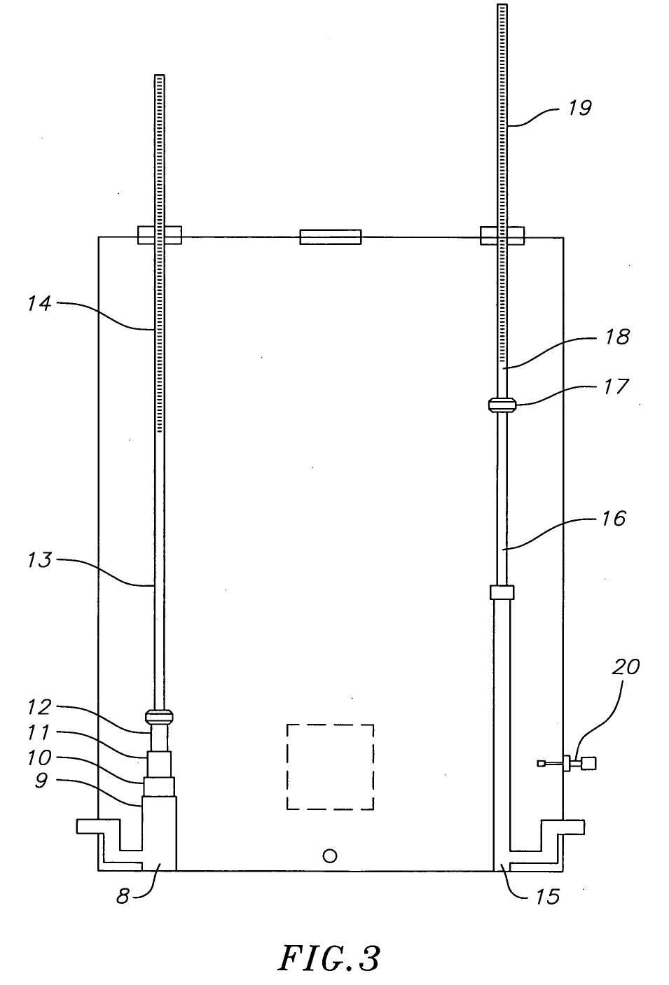

Managing liquids at variable levels within a storage tank may be accomplished using an adjustable height inlet/outlet orifice of a telescoping liquid management valve disclosed in U.S. Provisional Patent Application Ser. No. 60/651,239 filed Feb. 9, 2005. The telescoping liquid management valve allows a user to selectively add to or remove a selected liquid layer from a tank containing multiple liquid layers. A multi-stage telescoping liquid management valve 8 designed to work in the lower portion of a storage tank is shown in FIGS. 2 and 3. The valve has three telescoping sections 10, 11, and 12 with an inlet at the top of the final section 12. Attached to the inlet is the measuring and adjusting rod 13. Rod 13 may also have a gear rack 14 attached to the side or recessed into it. A single-stage telescoping liquid management valve 15 designed to operate in the upper portion of the tank is also shown in FIG. 3. The valve has a single telescoping section 16 with the housing 17 for the inlet/outlet orifice at the top. Attached to the housing 17 for the orifice is a rod 18, which may serve as a measuring stick as well as an adjusting rod. Rod 18 may also have a gear rack 19 on the side or recessed into it. A fixed-height, through-the-wall, sonar sensor 20 is also shown in FIG. 3. Sonar sensors are available from CTI Manufacturing of Snyder, Tex.

A sonar transducer 21 with a bi-directional pulse reflector 101 may be used as shown in FIG. 2. The sonar transducer 21 is positioned so that its pulse travels horizontally toward the center of pulse reflector 101. The reflector 101 has an upper reflector surface 102 at an angle of 45° relative to the horizontal and causes the sonar signal to be reflected vertically toward the top of the tank. The reflector 101 further has a lower reflector surface 103 at an angle of 45° relative to the horizontal, which causes the sonar signal to be directed vertically toward the bottom of the tank. The pulse reflector 101 is affixed to the housing of the orifice of a multi-stage telescoping liquid management valve. Configuring the transducer so that it sends sonar pulses horizontally and then changing the direction of the pulses (vertically, both up and down) via a reflector 101 eliminates the possibility of sediment settling on the face of the transducer 21, causing the sonar signal to degrade. A power and data transport cable 22 is attached to the transducer 21 on one end and to a sonar console 23 on the other end. The console 23 receives sonar signals from the transducer 21 and converts the signals into digital data. Consoles 23 such as this are available from CTI Manufacturing, as well as many other sources. The console may be capable of remote operation via Bluetooth technology, a worldwide protocol for short-range wireless communication. An optional DC power source 24 is shown, utilizing a Solar Panel 25 charging system. AC power is preferable, when available. A crank system 26 is shown for adjusting the inlet/outlet orifice of the telescoping liquid management valve.

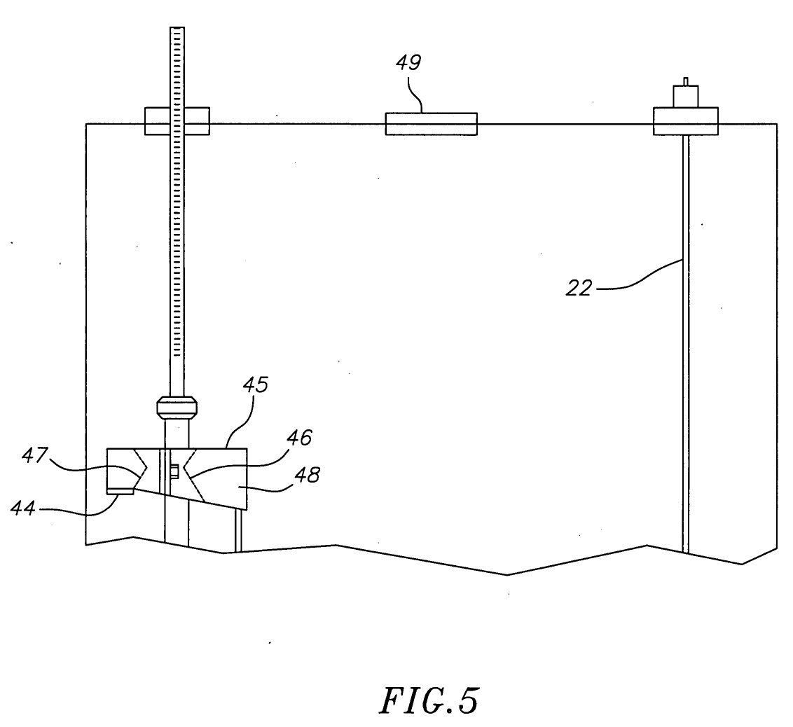

A motor-driven alternative to the cranking system of FIG. 2 is shown in FIG. 5. A brushless, 12 volt, 200 to 400 watt motor 40 may be used with reduction gearing 41 to adjust the position of the orifice of the valve at the desired rate. The motor may be either DC or AC, depending on available power sources. The motor is enclosed in an explosion-proof case and all wiring and connections meet federal and state guidelines for usage around combustible materials. The drive gear may be rotated with a crank 43, in the event of an electrical malfunction. A 25 amp, Pulse Width Modulator (available from PowerStream of Orem, Utah) with redundant shutdown protection may be used for motor control.

A sonar transducer 44 may be affixed to a Viton® float 45 (Viton is a DuPont plastic that is highly resistant to high temperatures as well as hydrocarbons and other toxic chemicals) as shown in FIG. 5. The float is shaped in such a way as to compensate for the weight of the transducer 44 and cable 22, allowing the face of the transducer 44 to rest parallel to the bottom of the tank. The float 45 is donut shaped and circumvents the adjusting rod 18 or the telescoping section 16 of the liquid management valve. The hole in the float is a double cone shape 46, allowing the float to easily slide over the elements of the valve. The float is constructed in two or more pieces 47, 48, allowing the pieces to be passed through the largest of the holes 49 at the top of the tank (8″) and assembled inside the tank. The two pieces 47, 48 may be fasted together by any effective method.

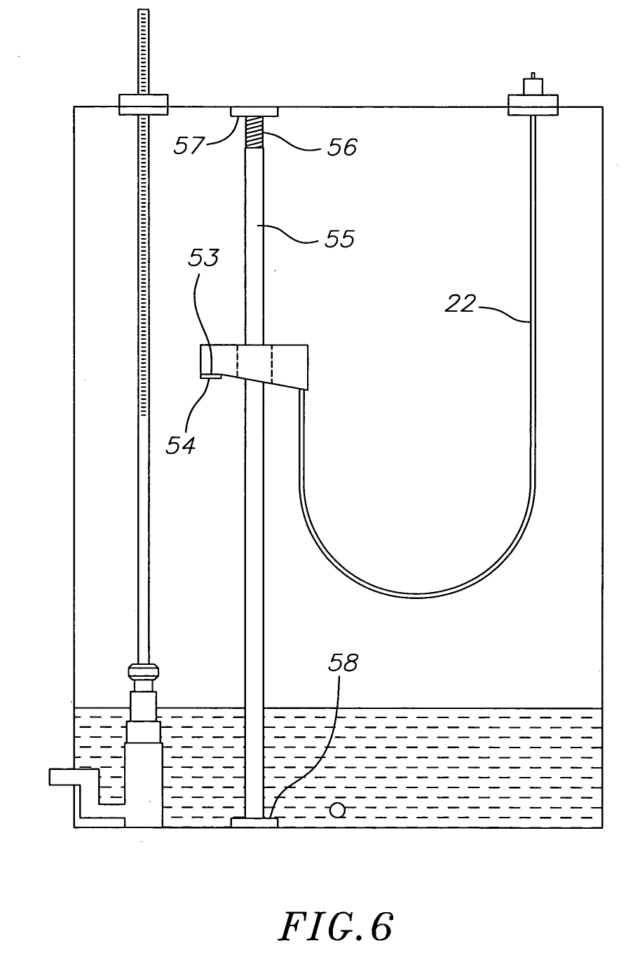

A sonar transducer 53 is affixed to a Viton® float 50 that moves vertically on a guide pole 55 as shown in FIG. 6. The float is shaped in such a way as to compensate for the weight of the transducer 53 and cable 22, allowing the face 54 of the transducer 53 to rest parallel to the bottom of the tank. The float 50 is donut shaped and circumvents the telescoping guide pole 55. The float is constructed in two or more pieces, allowing the pieces to be passed through the largest of the holes at the top of the tank (8″) and assembled inside the tank.

The pole 55 has a threaded insert at one end 56, allowing the installer to lengthen the pole so that it compresses to the top and bottom of the tank. The pole has enlarged, flattened areas 57, 58 at either end, to prevent the pole from slipping against the top and bottom of the tank. The pole is positioned close to the valve so that the transducer 53 can identify the position of the inlet/outlet orifice of the liquid management valve, even when liquid in the tank drops very low.

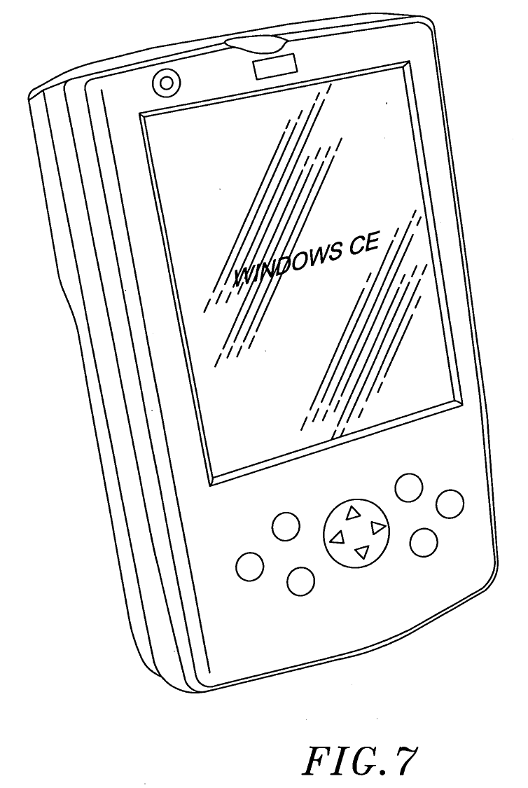

A diagram of the front of a programmable, Bluetooth-enabled PDA is shown in FIG. 7. Such a PDA is available from MIG, Palm, HP, and literally dozens of other manufactures and may be used by operators at well sites to interact with the Sonar system and motorized drive for the variable height inlet/outlet orifice. Bluetooth is a developing, world wide, open, short-range radio specification that defines communication protocols between devices and computers. In other words, off-the-shelf sonar consoles that are Bluetooth-enabled can communicate with Bluetooth enabled PDAs. A programmable PDA allows custom application software to be run on the PDA, completing the link between the PDA, the Sonar console, and an optional drive motor to adjust the position of a variable height inlet/outlet orifice.

Application software for the PDA may have the following characteristics:
Image rendering based on digital data from the Sonar console.
Interface controls that allow the operator to designate a stratified layer within a tank.
A Send control that allows the operator to tell the motor to position the inlet/outlet orifice at a certain layer.
For tanks having a ground-level crank, rather than a motor, application software may notify the operator when the orifice has reached the desired location.
Application software may include database capability, automatically logging the operator's identify, the tank being accessed, the time and date, and the specific gravity and quantity of liquid removed. The data may also include the temperature of the liquid and/or the specific gravity. This information may be used for custody transfer and /or inventory control.

A radio transmitter/receiver operating in the 900 MHz range, which is available from MaxStream of Lindon, Utah, may be used to transmit sonar data to a central location. In some instances, a 900 MHz device may be sufficient. In other instances, however, a repeater, or cellular modem, may be necessary to transmit/receive data.

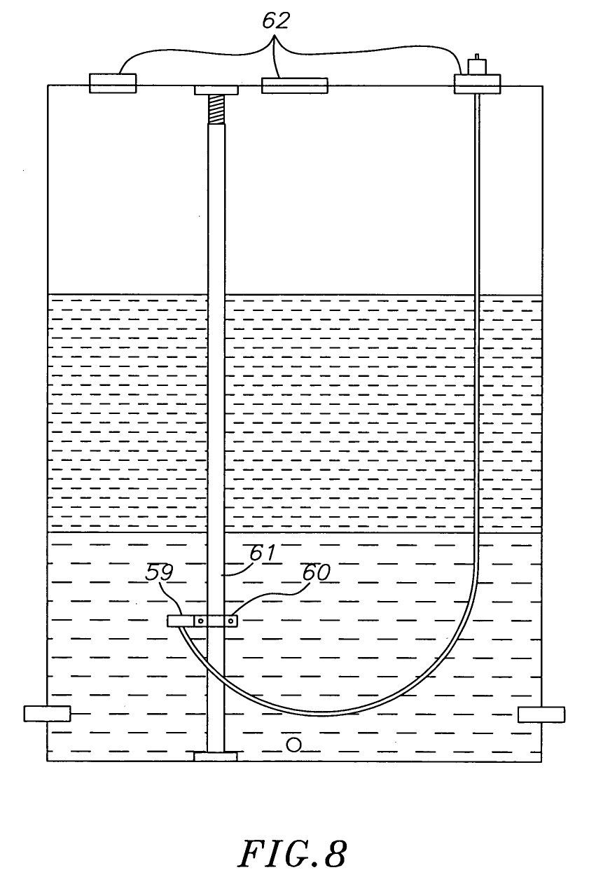

A bi-directional, specified-height transducer 59 is attached to a telescoping pole 61 as shown in FIG. 8. Depending on the type and quantities of stratified liquids in a tank, the transducer may be mounted at any point on the pole via an adjustable bracket 60 that can be loosened, slid to a particular location and retightened. This embodiment of the invention allows for the installation of a fixed-height sonar transducer in a tank without creating a hole in the side of the tank. The embodiment may be installed through existing holes 62 in the top of the tank while the tank is full of liquid.

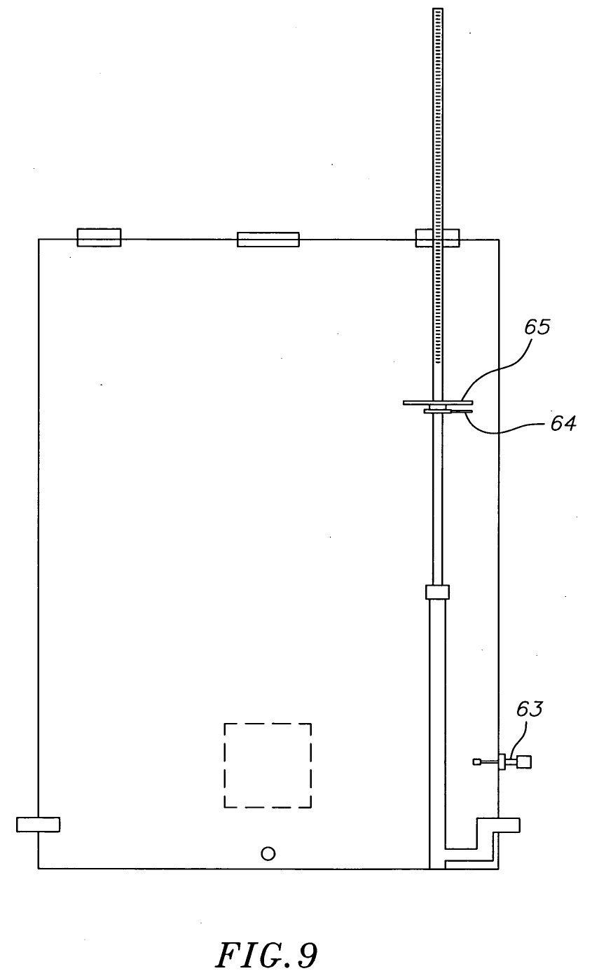

A through-the-wall, fixed-height sonar transducer 63, placed in close proximity to a valve, is shown in FIG. 9. A protrusion 64 may be added to the housing for the inlet/outlet orifice to facilitate detection by the sonar transducer. An alternative method involves exaggerating the size of either the top or bottom plates of the housing 65. By utilizing this configuration, the transducer is positioned in such a way that the sonar console knows precisely where the orifice is located in relation to the stratified layers.

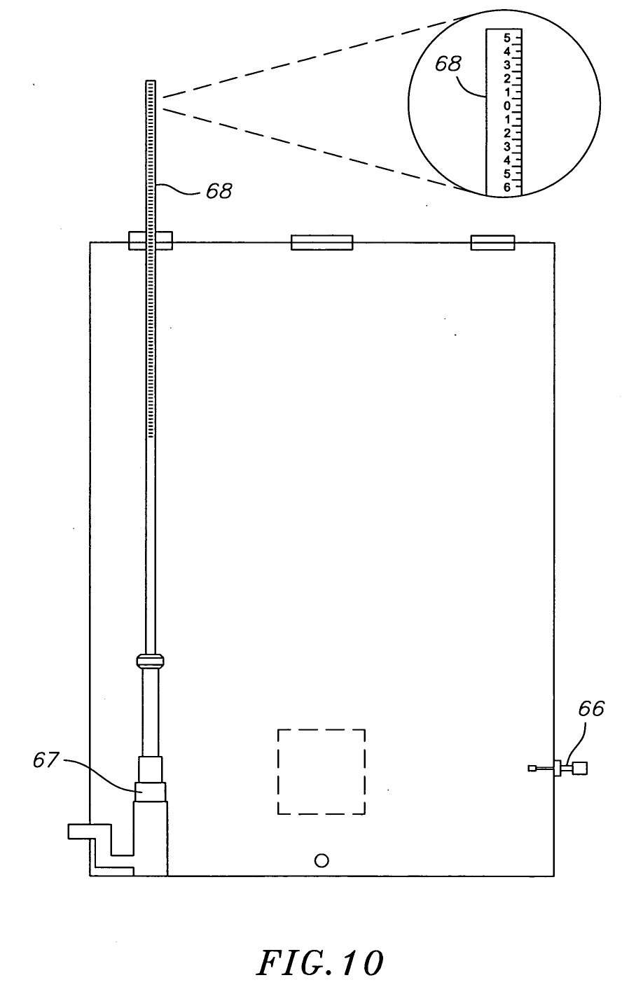

An in-tank sonar transducer 66 used in combination with a variable height inlet/outlet orifice of a valve is shown in FIG. 10. This basic approach allows an operator to utilize the sonar system to detect a stratified layer and then requires the operator to go to the top of the tank and manually adjust the position of the orifice based on a measuring and adjusting rod 68. A crank may also be used to raise or lower the orifice.

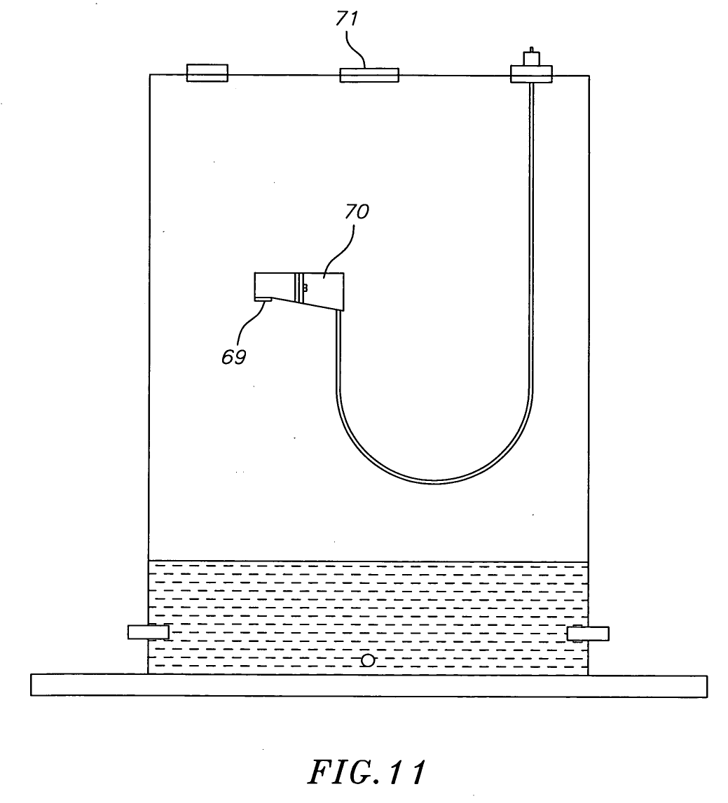

An in-tank, sonar transducer 69 mounted to a surface float 70 is shown in FIG. 11. The float may be smaller than 8″ in diameter to fit through the large opening 71 at the top of the tank. Alternatively, the float may be constructed in two or more pieces, allowing the pieces to be passed through the largest of the holes at the top of the tank (8″) and assembled inside the tank.

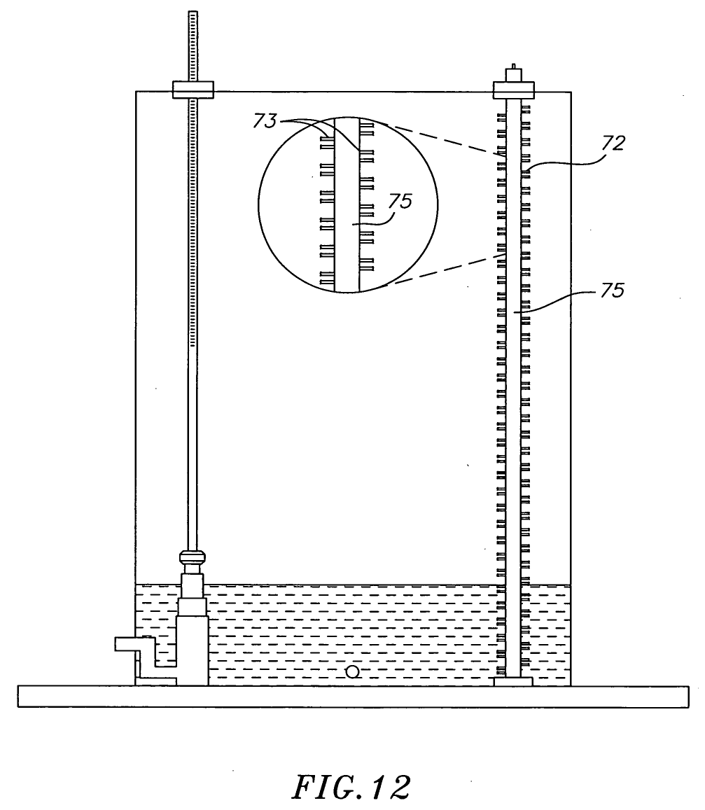

Several sets of electrical impedance sensors 72 attached to a telescoping pole 75 in such a way so as to provide readings of the specific gravities of liquids in a tank at close intervals, for example, every ½ inch or every inch is shown in FIG. 12. The pairs of sensor may be placed in two vertical rows 73 and staggered, so as to provide better coverage. Electrical impedance sensors test the resistance to electrical impulses inherent in liquid. The resistance to electrical impulses varies with the specific gravity of the liquid in different stratified layers.

The sensor pole 75 is used in conjunction with a variable height inlet/outlet orifice. This type of sensor does not detect the position of the orifice, and, therefore, the position of the orifice is set to the desired elevation by hand, based on data gathered from the sensor. Alternatively, a software feature may be added to both the desktop application and the handheld application to calculate the necessary position of the orifice based on a pre-set zero point for the orifice. The software, based on input from the sensor, knows where the desired level is relative to the zero point, and makes the necessary adjustment based on calculations involving the diameter of the gears and the number of revolutions of the drive motor shaft necessary to move the orifice the required distance.

This approach may be used with pairs of optical sensors, rather than electrical impedance sensors. Optical sensors detect the clarity of the liquid in the different stratified layers of liquids.

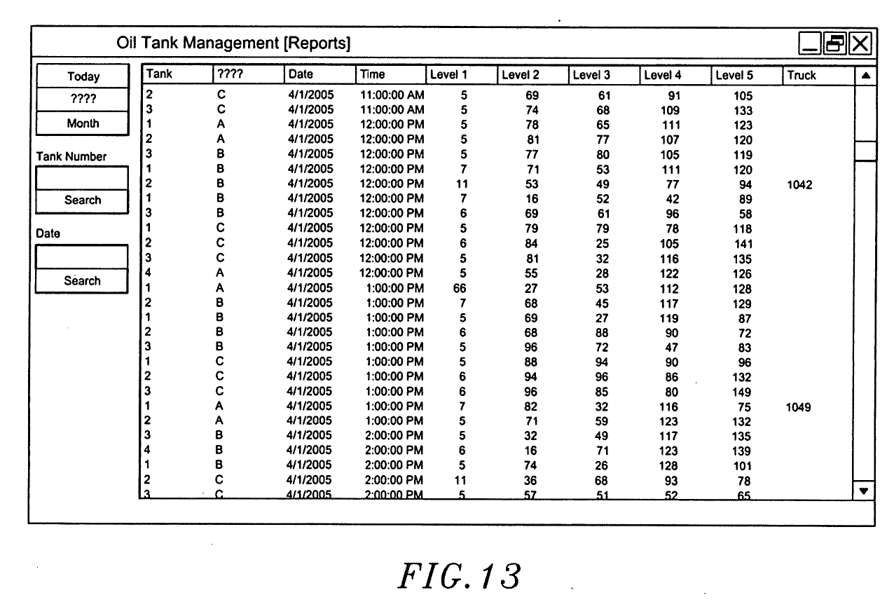

A graphical interface for a desktop software application that could be used to proactively manage hundreds, or even thousands, of storage tanks throughout a local oil field or a world-wide oilfield is shown in FIG. 13. The software, via wireless radio transmitter technology or a cellular modem, may be set to poll each tank on a regular basis—for example, once per hour—depending on the frequency desired by an operator. Based on the polling data received from each tank, the software may provide a variety of reports not now available to oil and gas companies. Further, the software may provide management assistance in planning daily, weekly, and monthly trucking schedules, thus eliminating significant unnecessary trucking charges that arise from pumpers dispatching trucks for less-than-a-load quantities. The software application may be set to upload critical tank data on a periodic basis to an Internet ISP/Storage facility, such as Center7, of Lindon, Utah. Such entities offer multiple layers of redundant security and data protection to customers that need high-volume data storage/archiving.

Salient features of the desktop software application are as follows:
Pre-set periodic polling or real-time access.
On-demand polling for specific tanks or lists of tanks.
Graphical representation of each tank, showing stratified layers, fill rate, percentage of hydrocarbons to water and other materials, as well as other relevant data specified by the operator.
Historical charts for specific wells showing the well performance over the course of time.
Methodology cost analysis. For example, the software may calculate the profitability of current methodology at a particular well site in relation to optional methodology. For example, at well sites utilizing three-phase heater/treaters, which are expensive to buy and to fuel on a monthly basis, the software may calculate the projected savings and ROI of converting to a variable height inlet/outlet orifice approach.
A daily tasks list, which automatically calculates, based on current volume and fill rates for all tanks, which tanks need which types of liquids drawn off and at what time.
A trucking planner; which would automatically coordinates trucking to a particular part of an oil field for the purpose of eliminating less-than-a-load dispatches. For example, the software, based on recent polling data, determines that tanks at three well sites each have 30 barrels of water that need to be removed. The software, therefore, recommends that a single 100-barrel water truck be dispatched to the region to draw off 30 barrels from each tank. This feature may be used on a daily basis or to forecast trucking requirements weeks and months into the future.
An oil-sales planner, which automatically coordinates possible oil sales on any given day. For example, based on recent polling data regarding current volumes of light oil in tanks as well as fill rates for those tanks, the software determines that six tanks in a particular geographic region contain a total of 100 barrels of light oil. Assuming these tanks utilize variable height orifices, an oil transport may be dispatched to a region to draw off the light oil from the six tanks.
Data reports with multiple sort keys. For example, an operator may want to generate a list of wells producing the highest ratio of hydrocarbons to water in descending order.

By way of example, and without limitation, the invention may be described as a system for managing stratified liquids in a container, such as a storage tank, comprising a variable height, in-tank sonar transducer (the transducer is moveable vertically in the container), configured to identify liquid layers of differing densities and to indicate an elevation of the liquid layers, and a motorized drive unit for adjusting the orifice of a liquid management valve to intercept a selected layer. In a manual system, an extended hand-crank may be provided to enable an operator to manually position the orifice while standing on the ground.

An external power source and a hand-held computer with a visual read-out that receives feedback from the in-tank sonar sensor via a wireless connection may transmit coordinates to the motor drive unit regarding orifice positioning. The hand-held computer automatically turns the motor off when the orifice has reached the optimal position, or alternately, notifies the operator that the orifice is in the optimal position. The hand-held computer includes on-board memory for storing tank management data, for example, which operator removed—or added—liquid from or to a stratified layer, the date and time of the operation and the volume of the liquid transported. The hand-held computer functionality may be replaced by other types of computers at remote locations which communicate with the in-tank sensor via various long-distance vehicles, such as radio frequency or microwave.

It is to be understood that the above-referenced arrangements are only illustrative of the application of the principles of the present invention in one or more particular applications. Numerous modifications and alternative arrangements in form, usage and details of implementation can be devised without the exercise of inventive faculty, and without departing from the principles, concepts, and scope of the invention as disclosed herein. Accordingly, it is not intended that the invention be limited, but rather the scope of the invention is to be determined as claimed.

1. Apparatus for managing stratified liquids in a container comprising a sonar transducer inside the container for identifying different liquid layers and the elevation of each in the container, a variable height inlet/outlet orifice, and means for positioning the orifice at a selected height in the container.

2. Apparatus for managing stratified liquids in accordance with claim 1, wherein the means for positioning is responsive to the output of the sonar transducer.

3. Apparatus for managing stratified liquids in accordance with claim 1, further comprising a housing for the orifice and wherein the housing carries the sonar transducer.

4. Apparatus for managing stratified liquids in a container comprising means inside the container for identifying zones or lines of transition between liquids and registering the elevation of each zone or line and means for moving the identifying means vertically inside the container.

5. Apparatus for managing stratified liquids in accordance with claim 4, wherein the moving means comprises a variable height inlet/outlet orifice housing adjustable from the exterior of the container.

6. Apparatus for managing stratified liquids in accordance with claim 4, further comprising a telescoping pole pushed against the top and bottom of the container and a carrier for the identifying means movable vertically about the pole.

7. Apparatus for managing stratified liquids in accordance with claim 6, wherein the carrier is a float.

8. A method for managing stratified liquids in a container comprising the steps of determining the level of the transition from one liquid to another, monitoring the level of each transition, and positioning an orifice at a selected level inside the container based on the level of each transition.

9. Apparatus for managing stratified liquids in a container comprising a sonar transducer inside the container for generating a signal indicative of a transition between stratified liquids, a variable height inlet/outlet orifice inside the container, means for controlling the position of the orifice, a computer with a display, the computer having application software for displaying an image based on the signal from the sonar transducer.

10. Apparatus in accordance with claim 9 further comprising interface controls which allow the user of the computer to designate a stratified liquid layer for addition to or removal and a send control operatively connected to move the orifice to a selected position inside the tank.

11. Apparatus according to claim 10 wherein the application software logs the identity of the user of the computer.

12. Apparatus according to claim 10 wherein the application software identifies and records the tank accessed by the user of the computer.

13. Apparatus according to claim 12 wherein the application software records the time and date that the user of the computer accesses a container.

14. Apparatus according to claim 13 wherein the application software further records the quantity of liquid removed from the container that is accessed.

15. Apparatus in accordance with claim 14 further comprising means for sensing the temperature of the liquid removed from the container.

16. Apparatus in accordance with claim 14 further comprising means for recording the specific gravity of the liquid removed from the container.

17. A method for managing stratified liquids in a container comprising the steps of determining the level of the transition from one liquid to another, monitoring the level of each transition, positioning an orifice at a selected level inside the container based on the level of each transition, recording the identity of the operator performing the steps of monitoring the level and positioning the orifice, identifying and recording the container accessed, the time and date of access, the quantity of liquid removed and recording the temperature of the liquid removed.

18. Apparatus for managing stratified liquids in a container comprising a sonar transducer inside the container for generating a signal indicative of a transition between stratified liquids, a variable height inlet/outlet orifice inside the container, a housing for the orifice, a sonar transducer mounted on the housing, a bi-directional pulse reflector spaced apart from the transducer in the horizontal path of the pulses from the transducer, the reflector having a first upper reflector surface to reflect the sonar pulses vertically toward the top of the container and a second lower reflector surface to reflect the sonar pulses vertically toward the bottom of the container.
